(19) United States
(12) Patent Application Publication
(10) Pub. No.: US 2022/0394422 A1
(43) Pub. Date: Dec. 8, 2022

(54) MOBILE DEVICE COMMUNICATION WITHOUT NETWORK CONNECTION

(71) Applicant: Waggle Corporation, Tampa, FL (US)

(72) Inventor: Glen Wheeler, Tampa, FL (US)

(21) Appl. No.: 17/336,370

(22) Filed: Jun. 2, 2021

(51) Int. Cl. H04W 4/021; H04W 76/11; H04W 4/02

(52) U.S. Cl. CPC H04W 4/022; H04W 76/11; H04W 4/023

(57) ABSTRACT

The present invention utilizes a method of using WIFI transmitters and mobile devices to communicate with a multitude of personal mobile devices in large crowded areas where network congestion would otherwise prevent the communication to the attendees, such as a concert event. The method teaches utilizing stationary WIFI emitters and the WIFI transmission capability of mobile devices to disseminate communications in the form of encoded instructions in a SSID to the event attendees.

### CROSS-REFERENCE TO RELATED APPLICATIONS

Not Applicable

### FIELD OF THE INVENTION

The present invention relates generally to wireless networking and more specifically communication between networks and mobile devices.

### BACKGROUND

When a large number of wireless devices are located in close proximity to each other, congestion will occur in the networks servicing these devices, and the effectiveness of these devices to receive data will be severely impaired, limiting the functionality of these devices.

Network congestion is a common occurrence at largely attended events such as concerts and sporting events. The large number of mobile devices located in the confines of the venues for these events, coupled with the tendency of people to post pictures to social media while they are at these events, as well live stream the events from their mobile devices, requires bandwidth which exceeds what the cellular networks can provide.

Wireless network providers have created a number of strategies to alleviate the congestion issues at these heavily attended events, such as the deployment of mobile cell sites, rapid deployment units (RDUs), cells on wheels (COWs) and cells on truck (COTs). These types of devices can help alleviate network congestion, but typically are more effective at providing functionality to lower bandwidth activities, such as texting and voice calls, than activities which require a larger amount of network bandwidth, such as updating application files and streaming data. Additionally, situations exist where deployment of mobile cell sites is inadequate to support even low bandwidth activities due to signal saturation issues.

Large venues which host these types of crowded events, such as stadiums, regularly can most effectively combat this network congestion through the installation of a WI-FI network at the venue which offers an alternative method of providing wireless data to mobile devices. However, even the most sophisticated WI-FI networks at these venues will have difficulty supporting live streaming data to or from thousands of mobile devices simultaneously.

The limitation of being able to live-stream presentations to mobile devices during largely attended events such as concerts, limits the ability of the presenter to communicate all media to the viewer that he may wish to.

During concerts, there may be media, such as music videos which are synchronized to the music, which could enhance the experience for the attender. At a large venue, such as an arena or stadium, this synchronized media could be presented via large screen viewing devices such as a jumbo Tron or the like.

Todays technology would enable this type of presentation through the transmission of a VHF or UHF transmitter, if the attendees had receivers for these types of transmissions. However, the typical mobile device used today, the smartphone, does not have VHF or UHF receivers incorporated into the device, if presenters wished to utilize this technology, they would need to provide attendees with devices which could receive this type of transmission, which would be costly to procure, and would likely lead to additional costs in damaged or stolen equipment.

U.S. Pat. No. 10,536,832, 10,154,396 and 10,674,335 by the current inventor (Wheeler), teach a method of using WIFI transmitters and mobile devices to provide synchronized media presentations on a multitude of personal mobile devices in large crowded areas where network congestion would otherwise prevent the transmission of these presentations to the attendees, such as a concert event. The patents teach the WIFI transmitters transmitting instructions to the mobile devices using the transmitters to emit WIFI SSIDs encoded with instructions for the devices to execute. However, one limitation of these patents is that if the event takes place in an area with a large footprint it will require the promoters to install a plurality of WIFI transmitters throughout the venue, which can be a costly endeavor.

Thus, there exists a need for a method to transmit encoded instructions from the event promoters to the mobile devices of the event attendees dispersed throughout the event grounds without the need to install numerous WIFI transmitters.

### SUMMARY

To accomplish this objective, the method of the present invention utilizes an application which is loaded onto the mobile devices of attendees who will be attending festivals, concerts, etc, where the large crowds attending the event will not be able to use typical networking such as cellular or wireless networks. The application will be pre-configured prior to the event to execute a set of instructions provided to the mobile device in the form of a WIFI SSID.

During the event, attendees will activate the applications loaded on their mobile devices, and the presenter will emit signals from at least one WIFI transmitter. The transmission will include a unique SSID which is encoded with a set of instructions that the detecting mobile device will execute.

The WI-FI mobile devices will not actually connect to the WIFI network. The broadcast name (SSID) of the WIFI device will include coded information including a set of instructions for the device to execute. When the mobile devices are in range of the WI-FI signal, the application will decode the signal and follow the instructions. No two-way data exchange on the WIFI network occurs, therefore, there is no network congestion issue. No network connections are established, therefore, no signal saturation issues occur.

In addition to being able to detect a signal from a transmitter, many electronic devices also have the capability to emit a SSID, in a similar manner to the transmitters discussed above. The encoded WIFI SSID described above will also include an instruction encoded into the SSID from the presenter for devices receiving the transmission to re-transmit the same instruction. By retransmitting the encoded SSID through the attendees' mobile devices the presenter will not only have coverage of the range of their transmitters, but will also have additional coverage from the transmissions from the mobile device re-transmission as well.

Using the mobile devices of the attendees to retransmit the event promoter's instructions allows the event promoters to ensure the transmissions are distributed throughout the event venue, while utilizing a minimum number of promoter owned transmitters, thus saving costs on equipment and installation.

### BRIEF DESCRIPTION OF THE DRAWINGS

FIG. 1 illustrates a schematic of the prior art communication system, using a two-way communication system to stream a presentation to multiple mobile devices;

FIG. 2 illustrates a schematic of the communication system of the current invention, using a one-way system to transmit an instruction to a mobile receiving/transmitting device within range of a transmitter, and to mobile receiving devices which are out of range of the transmitter using the internal transmitter of the first mobile receiving/transmitting device;

FIG. 3 illustrates a flow chart, depicting the operation of the application for using a one-way system to transmit an instruction with a hierarchy encoded in the instruction;

FIG. 4 illustrates a stage at a concert, and how the current method could be used to extend the range of the presenter's transmission.

### DETAILED DESCRIPTION OF THE INVENTION

Communication systems for distributing a presentation 100 to mobile devices utilizing four primary components, Controlling Station 101, an Emitting Station 102, at least one Mobile Receiving Device 103 with a Screen, and Application Software 104 loaded on the Mobile Receiving Device(s) 103.

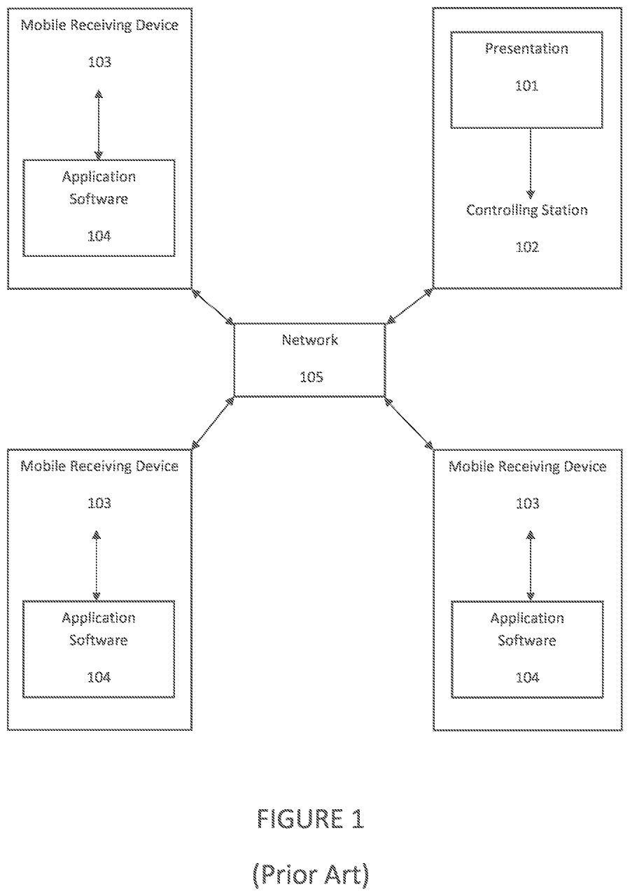

Referring to FIG. 1, conventional communication system for distributing a presentation to a Mobile Receiving Device 103 via a wireless signal from the Network 105, in the form of a wireless access point, require the Mobile Receiving Device 103 to attach to a wireless network 105, negotiate a common communication protocol and begin two-way communication of data. In the conventional method, the Mobile Receiving Device 103 will contain an application 104 which is loaded on the device. The Controlling Station 102 will communicate the presentation to the Mobile Receiving Devices 103 via the Wireless Network 105 in the form of Data. The Mobile Receiving Device 103 will have an application 104 loaded onto the device which is capable of converting that data into a viewable presentation on the screen of the Mobile Receiving Device 103. The receiving device 103 is required to maintain two way communication with the Wireless Network 105 in order for the application to work properly.

U.S. Pat. Nos. 10,536,832, 10,154,396 and 10,674,335 by the current inventor (Wheeler), teach a method of using Emitting Stations 102 and Mobile Receiving Devices 103 to provide synchronized media presentations on a multitude of personal Mobile Receiving Devices 103 in large crowded areas where network congestion would otherwise prevent the transmission of these presentations to the attendees, such as a concert event. The patents teach the Emitting Stations 102 transmitting instructions to the Mobile Receiving Devices 103 using the Emitting Stations 102 to emit WIFI SSIDs encoded with instructions for the Mobile Receiving Devices 103 to execute, therefore, the Mobile Receiving Devices 103 need to be within the range of the Emitting Stations 102 to work.

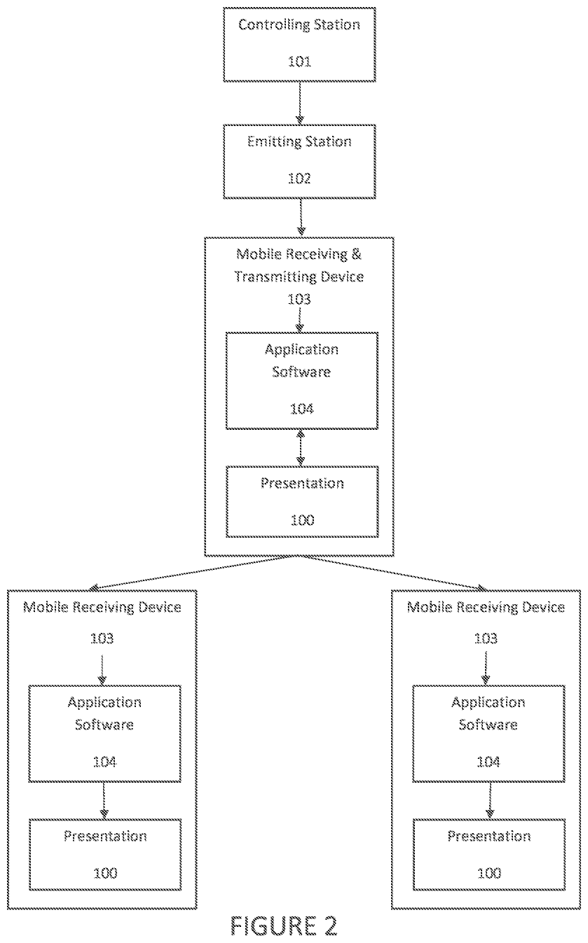

Referring to FIG. 2, the communication system of the current invention provides an alternative means for distributing information to Mobile Receiving Devices 103 via a wireless signal without establishing or requiring a network. This new method allows for the distribution of information via the method(s) taught in U.S. Pat. Nos. 10,536,832, 10,154,396 and 10,674,335, without the need for the Mobile Receiving Devices 103 to be within the range of the promoters Emitting Stations 102 to mobile devices. This novel and new communication system utilizes the transmitters installed in the attendees Mobile Receiving/Transmitting Devices 106 to retransmit Instructions emitted from the promoters Emitting Stations 102, allowing the transmission to reach Mobile Receiving Devices 103 and Mobile Receiving/Transmitting Devices 106 that are outside of the range of the promoters Emitting Stations 102.

The Controlling Station 101 is any device capable of sending instructions that are interpreted by an Emitting Station. The Controlling Station 101 instructs the Emitting Station to change its SSID to a specified name on demand. The Controlling Station 101 is made up of software designed to encode data and commands into an SSID that will be transmitted through the Emitting Station 102 and recognized and decoded by the desired Mobile Receiving Device 103 or Mobile Receiving/Transmitting Device 106 in a specific place at a specific time.

For example, the Controlling Station 101 could send a software command via a traditional local area network (LAN) to an Emitting Station 102. The Emitting Station 102 would interpret the command and change its SSID as instructed.

In the preferred embodiment the Emitting Station 102 is a device capable of emitting an IEEE 802.11x (Wi-Fi) signal and running specialized software written specifically for the purposes described in this patent application. Wireless access points typically emit an identifier called a Service Set identifier (SSID) which can be read by other Wi-Fi enabled devices. This system converts traditional Wireless Access Points and SSIDs for use as Emitting Stations 102. The corresponding software allows the Emitting Station 102 to accept commands from a Controlling Station 101 (over traditional communication methods). The Controlling Station 101 sends commands which will cause the Emitting Station 102 to change its SSID as directed.

While the Emitting Station 102 in the preferred embodiment of the current invention is a device capable of emitting a Wi-Fi signal, the inventor recognizes that there are a number of devices which are capable of wirelessly emitting a signal with a unique identifier which can be identified by the receiving station. Examples of other technologies which could be utilized as an emitting station 102 for the communication system of the present invention include, but are not limited to, Cellular Networks and short-wavelength UHF radio wave emitters. Additionally, the inventor recognizes that technology surrounding wireless communication is constantly evolving, and intends that this communication system could be adapted to work with developing technology which is capable of wirelessly emitting a signal with a unique identifier which can be identified by the receiving station

The Mobile Receiving Device 103 is any device that is capable recognizing communication networks and is capable of running the corresponding application software. Examples of technologies which could be utilized as a Mobile Receiving Device 103 for the communication system of the present invention include, but are not limited to, mobile devices, such as a cell phone or tablet, or computers, both laptops and desktops, which can run the corresponding application software.

A Mobile Receiving/Transmitting Device 106 is any device that is capable recognizing communication networks, capable of emitting a WIFI signal, and is capable of running the corresponding application software. Examples of technologies which could be utilized as a Mobile Receiving/Transmitting Device 106 for the communication system of the present invention include, but are not limited to, mobile devices, such as a cell phone or tablet, or computers, both laptops and desktops, which can run the corresponding application software.

The Mobile Receiving/Transmitting Device 106 have internal WIFI antennas which allow them not only to receive a WIFI signal from and emitting station, but also transmit a WIFI signal, which allows the Mobile Receiving/Transmitting Device 106 to send data in a WIFI network. The Mobile Device Receiving/Transmitting Device 106 internal WIFI antennas also allow the devices to serve as mobile “hotspots” which creates a secondary network which other devices can connect to. In order for the Mobile Receiving/Transmitting Device 106 to create a connectable hotspot, the Mobile Receiving/Transmitting Device 106 must also emit an SSID to be discovered. This SSID can be changed by the Mobile Receiving/Transmitting Device 106 user, or applications loaded on the Mobile Receiving/Transmitting Device 106. The Mobile Receiving/Transmitting Device 106 has the ability to modulate the strength of the WIFI signal it emits, allowing it to control the range of the SSID transmission around the device.

In traditional network communications, the user of the IEEE 802.11x (Wi-Fi) capable device must indicate a named network to join so that the device can begin negotiating with the network for a connection before communications can begin. The communication system of the current invention requires only the detection of the SSID by the Mobile Receiving Device 103. There is no need for the Mobile Receiving Device 103 to attach to the Emitting Station 102 or to any network device. There is also no need for the Mobile Receiving Device 103 to send any communication or acknowledgment back to the Emitting Station 102. Unlike a traditional Wi-Fi connection, the Emitting Station 102 does not need to determine if any Mobile Receiving Devices 103 are listening or not.

The number of Mobile Receiving Devices 103 and Mobile Receiving/Transmitting Devices 106 is limited only by the number of devices that can be physically located within the broadcasting range of the Emitting Station 103 or Mobile Receiving/Transmitting Devices 106. This is a significant advantage over existing network models which are hampered by the number of simultaneous Wi-Fi connections that they can support. Each connection to a traditional Wi-Fi network degrades the performance of the network for all other connected devices. For example, most industrial grade Wi-Fi routers can support a maximum of two hundred and fifty simultaneously connected devices. Bandwidth limitations on a Wi-Fi router would make supporting that many connections impractical. Since this new method repurposes the Wi-Fi router as a broadcaster only, the same Wi-Fi router, when used as an Emitting Station 102 or Mobile Receiving/Transmitting Devices 106, can manipulate thousands of devices at once with no degradation in performance.

The Emitting Station 102 and Mobile Receiving/Transmitting Devices 106 can broadcast instructions and data to any Mobile Receiving Device 103 or other Mobile Receiving/Transmitting Device 106 within range. The Mobile Receiving Device 103 or Mobile Receiving/Transmitting Device 106 scans the available detected SSIDs for a pattern match. Once a match is detected, the entirety of the SSID is deciphered by the application software. The SSID name can contain data and Instructions that are understood by the Mobile Receiving Device 103 or Mobile Receiving/Transmitting Device 106.

A first part of the SSID name is used by the Mobile Receiving Device 103 or Mobile Receiving/Transmitting Device 106 to establish a pattern match. For example, the Application Software 104 loaded on the Mobile Receiving Device 103 or Mobile Receiving/Transmitting Device 106 could be programmed to look for SSID's that begin with “MMSCOMMAND” or any other predetermined string. The Mobile Receiving Device 103 or Mobile Receiving/Transmitting Device 106 would ignore all SSID's that don't begin with the predetermined string.

A second part of the SSID name is used by the Mobile Receiving/Transmitting Device 106 to establish a instruct the Mobile Receiving/Transmitting Device 106 to retransmit the SSID. For example, the Application Software 104 loaded on the Mobile Receiving/Transmitting Device 106 could be programmed to recognize SSID's that Include “TRANSMIT”. A Mobile Receiving/Transmitting Device 106 would recognize this instruction, and retransmit the SSID, in addition to executing the instruction. A Mobile Receiving Device 103 would only execute the instruction and ignore the command to retransmit.

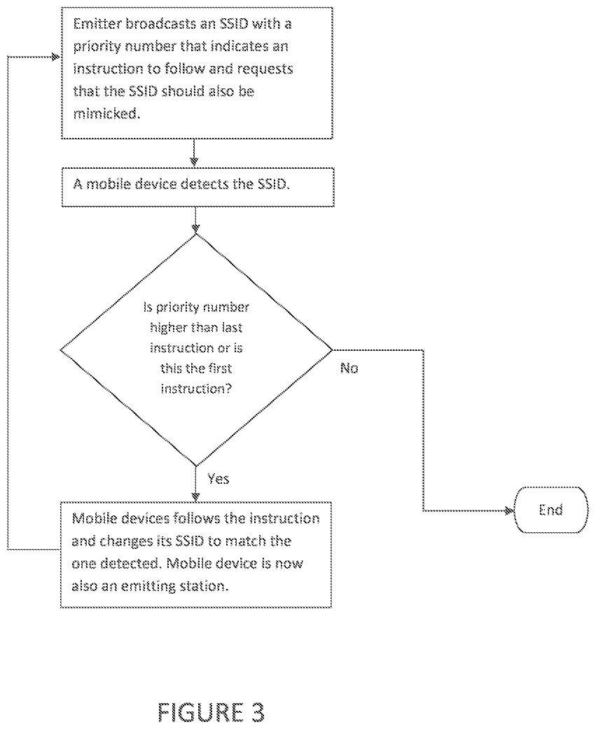

Referring to FIG. 3, a third part of the SSID name is used by the Mobile Receiving/Transmitting Device 106 to establish the hierarchy of commands that Mobile Receiving Device 103 or Mobile Receiving/Transmitting Device 106 are to execute. Occasionally, during an event, the promoter may wish to change the instructions, and because the instructions are being transmitted from multiple devices, a hierarchy of commands should be established to all a detecting Mobile Receiving Device 103 or Mobile Receiving/Transmitting Device 106 to distinguish the most recent set of instructions. For example, the Application Software 104 loaded on the Mobile Receiving/Transmitting Device 106 could be programmed to recognize SSID's that include “LVL” and a number after the LVL which indicates hierarchy, e.g. “LVL4”. If a Mobile Receiving Device 103 or Mobile Receiving/Transmitting Device 106 sees two SSIDs, one which includes “LVL4” and one which include “LVL5,” it will know that the SSID with “LVL5” is the most recent instruction, and execute that instruction.

The remaining SSID characters are then deciphered by the Mobile Receiving Device 103 or Mobile Receiving/Transmitting Device 106. The characters can be interpreted by the Application Software to execute functions and inject data. In a first embodiment, “MMSCOMMANDTRANSMITLVLSQ52TS122412” could be broken down as “MMSCOMMAND”, “TRANSMIT”, “LVL5”, “Q52”, and “TS122412”. “MMSCOMMAND” could cause the Application Software 104 to read the SSID and decipher the remaining characters. “Q52” could correspond to a preprogrammed set of instructions in the Application Software 104, such as an instruction to play a specific media file already loaded onto the Mobile Receiving Device 103 or Mobile Receiving/Transmitting Device 106. “TS122412” could be interpreted by the Mobile Receiving Device 103 or Mobile Receiving/Transmitting Device 106 as a timestamp corresponding to “12:24:12 AM”.

The Application Software 104 could then execute a set of instructions triggered by the encoded SSID. In this example, the Mobile Receiving Device 103 or Mobile Receiving/Transmitting Device 106 might begin playing the “Q52” file from a designated timestamp by adding the difference between the current time and the encoded timestamp “12:24:12 AM”. If the SSID is interpreted by the Mobile Receiving Device 103 or Mobile Receiving/Transmitting Device 106 at 12:24:32 AM, then the Q52 file would begin playing at the 20 second mark. This would allow a large number of Mobile Receiving Devices 103 or Mobile Receiving/Transmitting Devices 106 to play synchronized content on demand without actually being connected to any type of network.

If there was an unanticipated interruption in the performance, that lead to the media file being out of sync with the performance by 2 minutes and 30 seconds, the promoter could change the SSID transmitted from the Emitting Station 102 to “MMSCOMMANDTRANSMITLVL6Q52TS122642” which could be broken down as “MMSCOMMAND”, “TRANSMIT”, “LVL6”, “Q52”, and “TS122642”. “MMSCOMMAND” could cause the Application Software 104 to read the SSID and decipher the remaining characters. A Mobile Receiving Device 103 or Mobile Receiving/Transmitting Device 106 seeing both SSIDs “MMSCOMMANDTRANSMITLVL6Q52TS122642” and “MMSCOMMANDTRANSMITLVLSQ52TS122412” would recognize “LVL6” as being greater than the previous “LVL5” and give that instruction priority. “TS122642” would be interpreted by the Mobile Receiving Device 103 or Mobile Receiving/Transmitting Device 106 as a timestamp corresponding to “12:26:42 AM” and the Application Software 104 would resync with the performance based on the new timestamp.

In a second embodiment of the invention the Application Software 104 can also display formatted text on the screen of the Mobile Receiving Device 103. This function can be used to transmit mass messages to all attendees in within range of an Emitting Station 102. It can be used enhance the event, such as providing updates when certain acts are about to start performing, or can be used as a safety device as well, alerting attendees of event issues, such as fires or terrorist attacks, and providing directions to the nearest exits. An SSID of “MMSCOMMANDTRANSMITLVL6F1S2C3BAND_X_IS STARTING_ON_STAGE_A” could be broken down as “MMSCOMMAND”, “TRANSMIT”, “LVL5”, “F1”, “S2,” “C3,” and “BAND_X_IS STARTING_ON_STAGE_A”. “MMSCOMMAND” could cause the Application Software 104 to read the SSID and decipher the remaining characters. “F1” could correspond to a preprogrammed set of instructions in the Application Software 104 to display a particular text font, “S2” could correspond to a preprogrammed set of instructions in the Application Software 104 to display a particular text size and “C3” could correspond to a preprogrammed set of instructions in the Application Software 104 to display a particular text color. The message “BAND X IS STARTING ON STAGE A” would then be displayed on the screen of the Mobile Receiving Device 103 in the specified font and size.

If there was an error in the message the promoter could retransmit a new SSID of “MMSCOMMANDTRANSMITLVL6F1S2C3BAND_Y_IS STARTING_ON_STAGE_A” could be broken down as “MMSCOMMAND”, “TRANSMIT”, “LVL6”, “F1”, “52,” “C3,” and “BAND_Y_IS STARTING_ON_STAGE_A”. A Mobile Receiving Device 103 or Mobile Receiving/Transmitting Device 106 seeing both SSIDs would recognize “LVL6” as being greater than the previous “LVL5” and give that instruction priority.

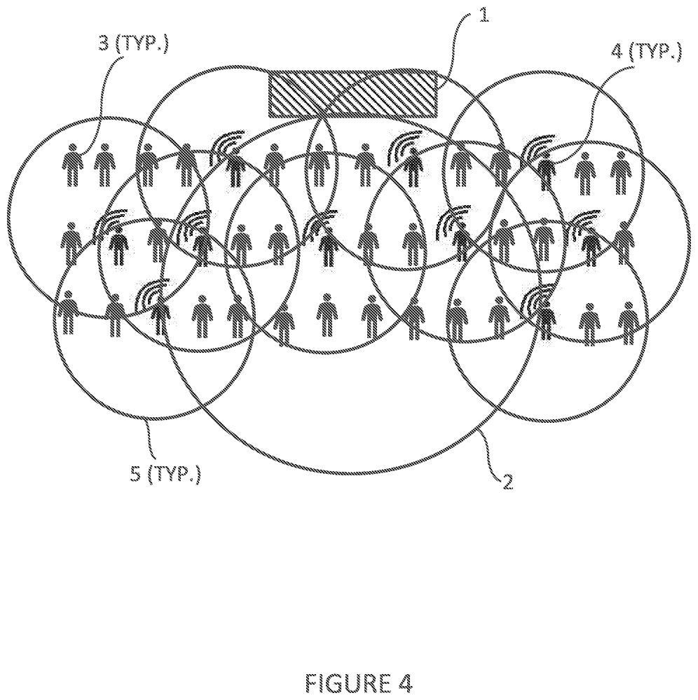

Referring to FIG. 4, an example of how the communication system of the current invention could be utilized. An event venue is constructed that will have a Stage 1 with Emitting stations located at the stage 1. The emitting stations are configured so that the range of the SSID transmitted by the emitting station 2 will extend into the crowd, but not to all attendees 3 & 4. There will be attendees with a mobile receiving device 3 and attendees with mobile receiving/transmitting device 4 that are capable of retransmitting an SSID over a smaller range 5. Attendees 3 & 4 who are not within the range of the SSID transmitted by the emitting stations 2 will still receive the instructions, as the devices will be within the range 5 of the SSIDs retransmitted by the mobile receiving/transmitting devices 4.

While the above embodiment contemplates utilizing cellular phones as the mobile receiving/transmitting device 4 to retransmit a SSID, this function could be preformed by a number of other types of devices, such as laptop computers, tablets, and WIFI routers. Any portable device, or combination of devices capable of receiving and transmitting a WIFI signal can perform the function of a mobile receiving/transmitting device 4.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method of communicating with mobile devices comprising:
providing at least one emitting station which transmits at least one unique wireless network signal over a range identified with a unique network identifier, said network signal functionality being limited to transmitting a unique network identifier and said network signal not allowing mobile devices to connect to the network signal;
providing a plurality of first mobile devices being capable of detecting a wireless network signal, and emitting a unique wireless network signal over a range;
providing a plurality of second mobile devices capable of detecting a unique wireless signal with an application loaded on the mobile device;
encoding said unique wireless network signal with a set of instructions in the network identifier that include and instruction to retransmit the unique wireless network signal;
said first mobile devices detecting the encoded unique wireless signals, but not establishing a connection to the network signal, and executing the instruction to retransmit the unique wireless network signal;
said second mobile devices being located outside of the range of the emitting station but within the range of the first mobile devices;
said second mobile devices detecting the encoded unique wireless signals, but not establishing a connection to the network signal, and the application decoding the instructions encoded in the network identifier and executing the instructions.

2. The method of communicating with mobile devices claim 1 wherein said unique wireless network signal with a set of Instructions in the network identifier further comprises a hierarchy identifier that prioritizes a network identifier to for the mobile devices to execute, in the event that the mobile devices detect more than one different unique wireless network signals.

3. The method of communicating with mobile devices of claim 2 wherein said network identifier further comprises an instruction detailing text to be displayed on a screen of the mobile device from and said application displaying the desired text on the screen of the mobile device.

4. The method of communicating with mobile devices of claim 2 wherein said mobile devices have presentation files loaded in the mobile devices and said encoded network identifier further comprises instructions for said application to access and display the presentation on the screen of the mobile devices.
